(19) United States
(12) Patent Application Publication
(10) Pub. No.: US 2023/0393358 A1
(43) Pub. Date: Dec. 7, 2023

(54) FIBER OPTIC CABLE FOR DOWNHOLE AND HARSH ENVIRONMENTS

(71) Applicants: Neubrex Energy Services, Inc., Stafford, TX (US); NEUBREX CO., LTD., Kobe-shi (JP)

(72) Inventor: Kinzo KISHIDA, Kobe-shi (JP)

(73) Assignees: Neubrex Energy Services, Inc., Stafford, TX (US); NEUBREX CO., LTD., Kobe-shi (JP)

(21) Appl. No.: 18/328,314

(22) Filed: Jun. 2, 2023

Related U.S. Application Data
(60) Provisional application No. 63/348,235, filed on Jun. 2, 2022.
(60) Provisional application No. 63/368,702, filed on Jul. 18, 2022.

(51) Int. Cl. G02B 6/44

(52) U.S. Cl. CPC G02B 6/4413

(57) ABSTRACT

A fiber optic cable includes a braided core defining a plurality of helical grooves, and one or more optical fibers disposed along one or more of the helical grooves of the braided core. The elongated structures braided to form the braided core are composed of braided ropes or monolithic wires. An outer layer disposed over an outer surface of the braided core is composed of a metal layer or a flexible plastic layer.

### CROSS-REFERENCES TO RELATED APPLICATIONS

This application claims the benefit of U.S. Provisional Patent Application No. 63/348,235 filed on Jun. 2, 2022, and U.S. Provisional Patent Application No. 63/368,702 filed on Jul. 18, 2022, the entire content of each of which is incorporated herein by reference for all purposes.

### TECHNICAL FIELD

The present disclosure relates to a fiber optic cable configured for downhole and harsh environments.

### BACKGROUND INFORMATION

Distributed Fiber Optic Sensing (DFOS) technology is being developed for a wide variety of uses including sensing of deformation, temperature, pressure, and sound, and for a variety of environments, including harsh environments such as within the oil and gas industry, civil engineering field, as well as military usages. Fiber optic cables used in such systems can include multiple optical fibers, and can utilize a combination of, for example, Rayleigh scattering and Brillouin scattering analyses, to determine the various parameters.

Reliability and adaptability of these technologies at a reasonable cost continues to be emphasized. For example, a fiber optic cable having an outer tube can provide inaccurate strain results if the outer tube becomes loose. Furthermore, the fiber optic cable needs to be able to withstand high lateral pressures. Finally, there have been challenges in ensuring the ability to make various connections to the fiber optic cable in a quick, cost-effective, reliable manner.

### SUMMARY

A fiber optic cable includes a braided core defining a plurality of helical grooves, and one or more optical fibers disposed along one or more of the helical grooves of the braided core. The elongated structures braided to form the braided core are composed of braided ropes or monolithic wires. An outer layer disposed over an outer surface of the braided core is composed of a metal layer or a flexible plastic layer.

### BRIEF DESCRIPTION OF THE DRAWINGS

Other features and advantages disclosed herein will become more apparent from the following detailed description of exemplary embodiments when read in conjunction with the attached drawings.

FIG. 1 illustrates a side perspective view of a braided core of a fiber optic cable according to a first variation of a first embodiment.

FIG. 2 illustrates a cross-section view of a fiber optic cable according to a second variation of a first embodiment.

FIG. 3A illustrates a cross-section view of a fiber optic cable according to a first variation of a second embodiment.

FIG. 3B illustrates a cross-section view of a fiber optic cable according to a second variation of a second embodiment.

### DETAILED DESCRIPTION

Set forth below with reference to the accompanying drawings is a detailed description of embodiments of a fiber optic cable, representing examples of an inventive fiber optic cable.

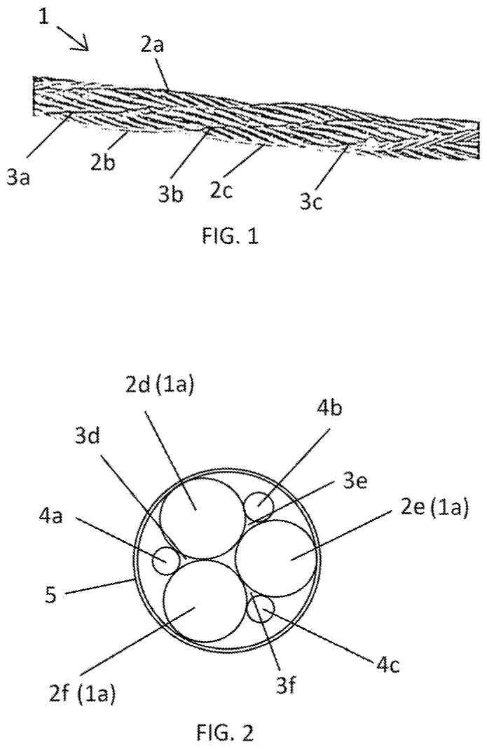

Fiber optic cables according to embodiments of the present application include a braided core. An exemplary braided core 1 for a fiber optic cable is illustrated in FIG. 1. The braided core 1 in the embodiment is composed of three braided ropes 2a, 2b, 2c which are themselves braided together to define three helical grooves 3a, 3b, 3c. The material of the strands making up the braided ropes 2a, 2b, 2c can be, for example steel or polymer wire. An example of polymer wire is K-FRP which means Kevlar—Fiber Reinforced Plastic wire. As discussed below, in a fiber optical cable using the braided core 1, one or more optical fibers are disposed in one of more of the helical grooves 3a, 3b, 3c, and a metal layer is provided outside the braided core 1 and optical fibers.

FIG. 2 illustrates a schematic cross section of a fiber optic cable using a similar braided core 1a as the braided core 1 of FIG. 1. However, in this braided core, in place of each braided rope 2a, 2b, 2c, elongated structures 2d, 2e, 2f that are instead monolithic wire, i.e., plano wire, made of steel or polymer, are used as the strands of the braided core 1a. The braided structure of the braided core 1a will again result in helical grooves 3d, 3e, 3f. As illustrated in the figure, an optical fiber 4a, 4b, 4c is disposed in each of the grooves 3d, 3e, 3f.

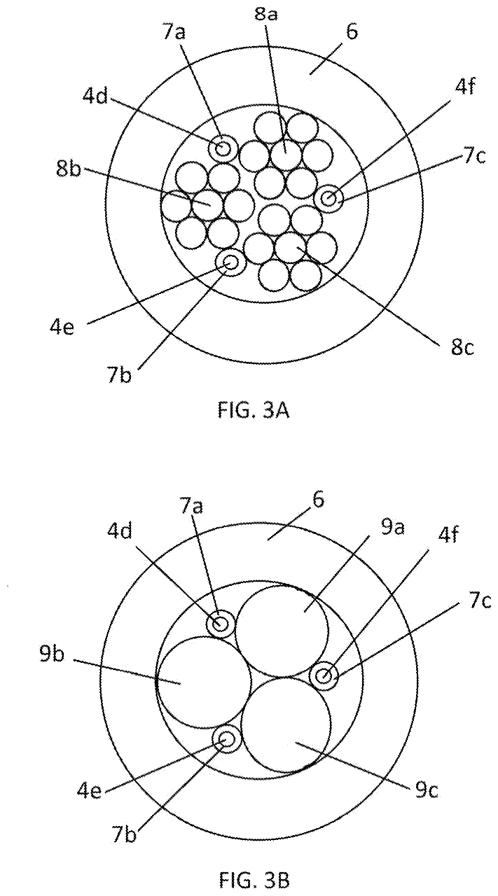

In the embodiment of FIGS. 1 and 2, the diameter of the braided rope 2a, 2b, 2c, or monolithic wire 2d, 2e, 2f, can be 3.37 mm, and the diameter of the optical fiber can be 1.2 mm, for example. The optical fibers of the embodiment can be multi-core fiber modules, so as to increase the redundancy and provide more choices for fiber optic connection. Alternatively, single-core optical fibers of smaller size can be used, which would also enable downsizing of the braided core. Additionally, a metal layer 5 of, for example, steel, is disposed over the outer surface of the braided core 1a and optical fibers 4a, 4b, 4c, so that the resultant fiber optic cable is armored. Note that while three optical fibers 4a, 4b, 4c are pictured, there could also be only one or two optical fibers, with the other groove or grooves left vacant. This is also the case in the embodiments of FIGS. 3A and 3B discussed below.

FIGS. 3A and 3B illustrate schematic cross sections of a fiber optic cable which instead of being armored, is provided with a flexible plastic sheath 6 over the braid core and optical fibers. In these embodiments, because a relative soft sheath is used instead of a relatively hard armor coating as in the FIG. 2 embodiment, the optical fibers 4d, 4e, 4f are themselves provided with a respective heavy duty overcoat 7a, 7b, 7c, such as TPE.

The fiber optic cables of FIGS. 3A and 3B differ from each other in that the fiber optic cable of FIG. 3A uses three braided ropes 8a, 8b, 8c to make up the three elongated elements of the braided core, whereas the fiber optic cable of FIG. 3B uses three monolithic wires 9a, 9b, 9c as the three elongated elements of the braided core. Note that in the embodiment of FIG. 3A, each braided rope 8a, 8b, 8c is made up of a central strand with six strands of approximately same diameter helically wound therearound.

In the embodiments of FIGS. 3A and 3B, the diameter of the braided ropes 8a, 8b, 8c or monolithic wires 9a, 9b, 9c is 1.6 mm, and the diameter of the optical fibers 4d, 4e, 4f (including their overcoats 7a, 7b, 7c) is 0.5 mm, for example, such as single-core optical fibers. However, these optical fibers 4d, 4e, and 4f can also be multi-core fiber modules, which may be of larger size, and can be usable with a larger braided core. As discussed above, utilization of multi-core fiber modules can increase the redundancy and provide more choices for fiber optic connection. Note that in all of the embodiments, the respective diameters are selected so that the optical fibers are entirely within and inwardly spaced from a circle defined by the largest diameter of the braided core (for example, within and spaced from the inner circumference of the metal layer 5 in the FIG. 2 embodiment, and within and spaced from the inner circumference of the sheath 6 in the embodiments of FIGS. 3A and 3B).

Fiber optic cables according to the present application are able to accurately measure strain because the design avoids loose outer tubing from causing slippage of the optical fiber. Furthermore, such fiber optic cables have high lateral strength, and it is relatively easy to connect to the optical fibers because, unlike other designs, they are not covered by other wires.

It will be appreciated by those skilled in the art that the disclosure herein can be embodied in other specific forms without departing from the spirit or essential characteristics thereof. The presently-disclosed embodiments are therefore considered in all respects to be exemplary and not restricted. The scope of the invention is indicated by the appended claims rather than the foregoing description and all changes that come within the meaning and range and equivalence thereof are intended to be embraced therein.

What is claimed is:

1. A fiber optic cable, comprising:
a braided core defining a plurality of helical grooves, and
one or more optical fibers disposed along one or more of the helical grooves of the braided core.

2. The fiber optic cable of claim 1, wherein the braided core is composed of a plurality of wires braided together.

3. The fiber optic cable of claim 2, wherein the wires are steel wires.

4. The fiber optic cable of claim 2, wherein the wires are polymer wires.

5. The fiber optic cable of claim 1, wherein the braided core is composed of a plurality of braided ropes braided together.

6. The fiber optic cable of claim 1, wherein the braided core consists of three elongated structures braided together.

7. The fiber optic cable of claim 1, further comprising an outer layer disposed over an outer surface of the braided core and the one or more optical fibers.

8. The fiber optic cable of claim 7, wherein the outer layer comprises a flexible plastic layer.

9. The fiber optic cable of claim 7, wherein the outer layer comprises a metal layer.

10. The fiber optic cable of claim 1, wherein at least one of the one or more optical fibers comprises a fiber module having more than one optic core.
